(19) United States
(12) Patent Application Publication
(10) Pub. No.: US 2026/0362268 A1
(43) Pub. Date: Nov. 12, 2026

(54) SECURITY KEY DERIVATION FOR SWITCHING SERVING CELLS

(71) Applicant: Lenovo (United States) Inc., Morrisville, NC (US)

(72) Inventors: Prateek Basu Mallick, Dreieich (DE); Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/203,073

(22) Filed: May 8, 2025

(51) Int. Cl. H04W 36/08; H04W 12/041; H04W 12/043; H04W 36/00; H04W 76/20

(52) U.S. Cl. CPC H04W 36/08; H04W 12/041; H04W 12/043; H04W 36/0079; H04W 36/00835; H04W 76/20

(57) ABSTRACT

Various aspects of the present disclosure relate to security key derivation for switching serving cells. A user equipment (UE) may receive first signaling that indicates a set of candidate cells for cell reselection. The UE receives second signaling that indicates a first candidate cell of the set of candidate cells for the cell reselection. The UE obtains a security key corresponding to a second candidate cell of the set of candidate cells based on a failure of a cell switch procedure for the first candidate serving cell. The UE obtains the security key using security key derivation information associated with at least one of the second candidate cell or a current cell. The UE performs the cell switch procedure for the second candidate cell based on the security key.

### TECHNICAL FIELD

The present disclosure relates to wireless communications, and more specifically to mobility procedures for devices.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first signaling that indicates a set of candidate cells (e.g., serving cells) for a cell reselection procedure (e.g., a cell switch procedure), receive second signaling that indicates a first candidate cell of the set of candidate cells for the cell reselection, obtain, based on a failure of a cell reselection procedure for the first candidate cell, a security key corresponding to a second candidate cell of the set of candidate cells using security key derivation information associated with at least one of the second candidate cell or a current cell, and perform, based on the security key, the cell reselection procedure for the second candidate cell.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates a set of candidate cells for a cell reselection, receive second signaling that indicates a first candidate cell of the set of candidate cells for the cell reselection, obtain, based on a failure of a cell reselection procedure for the first candidate cell, a security key corresponding to a second candidate cell of the set of candidate cells using security key derivation information associated with at least one of the second candidate cell or the current cell, and perform, based on the security key, the cell reselection procedure for the second candidate cell.

A method performed or performable by a UE for wireless communication is described. The method may include receiving first signaling that indicates a set of candidate cells for a cell reselection, receiving second signaling that indicates a first candidate cell of the set of candidate cells for the cell reselection, obtaining, based on a failure of a cell reselection procedure for the first candidate cell, a security key corresponding to a second candidate cell of the set of candidate cells using security key derivation information associated with at least one of the second candidate cell or the current cell, and performing, based on the security key, the cell reselection procedure for the second candidate cell.

In some implementations of the UE, the processor, and the method described herein, the UE, the processor, and the method may further be configured to, capable of, or operable to receive second signaling that indicates the second candidate cell and second key derivation information, where the security key derivation information is associated with the second candidate cell. In some implementations of the UE, the processor, and the method described herein, the UE, the processor, and the method may further be configured to, capable of, or operable to receive first signaling that includes a set of identifiers of the set of candidate cells and an identifier of the current cell, and select the second candidate cell based on a respective identifier of the second candidate cell having a same value as the identifier of the current cell. In some implementations of the UE, the processor, and the method described herein, the UE, the processor, and the method may further be configured to, capable of, or operable to initiate a timer associated with the cell reselection procedure, perform, based at least in part on initiating the timer, the cell reselection procedure for the first candidate cell, where the cell reselection procedure for the first candidate cell is from the current cell to the first candidate cell, and determine that the cell reselection procedure has failed for the first candidate cell based on expiry of the timer.

In some implementations of the UE, the processor, and the method described herein, the UE, the processor, and the method may further be configured to, capable of, or operable to receive second signaling that includes at least one of a next-hop chaining counter (NCC) associated with a handover complete message in radio resource control (RRC) signaling from the first candidate cell, an identifier of the first candidate cell, or a timing advance (TA) associated with the first candidate cell. In some implementations of the UE, the processor, and the method described herein, the security key derivation information includes at least one of an NCC associated with at least one of the current cell or the second candidate cell, a frequency corresponding to the second candidate cell, or a physical cell identity (PCI) corresponding to the second candidate cell. In some implementations of the UE, the processor, and the method described herein, the first signaling includes RRC signaling, and the second signaling includes a medium access control (MAC)-control element (MAC-CE).

An NE (e.g., a base station) for wireless communication is described. The NE may be configured to, capable of, or operable to perform one or more operations as described herein. For example, the NE may be configured to, capable of, or operable to transmit first signaling that indicates a set of candidate cells for a cell reselection, and transmit second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates a set of candidate cells for a cell reselection, and transmit second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell.

A method performed or performable by an NE (e.g., a base station) for wireless communication is described. The method may include transmitting first signaling that indicates a set of candidate cells for a cell reselection procedure, and transmitting second signaling that indicates a first candidate cell of the set of candidate cells for the cell reselection, where a security key corresponding to a second candidate cell of the set of candidate cells is based on security key derivation information associated with at least one of the second candidate cell or a current cell in response toa failure of a cell reselection procedure for the first candidate cell.

In some implementations of the NE, the processor, and the method described herein, the NE, the processor, and the method may further be configured to, capable of, or operable to transmit second signaling that indicates the second candidate cell and second key derivation information, where the security key derivation information is associated with the second candidate cell. In some implementations of the NE, the processor, and the method described herein, the NE, the processor, and the method may further be configured to, capable of, or operable to transmit first signaling that includes a set of identifiers of the set of candidate cells and an identifier of the current cell, where the second candidate cell is selected based on a respective identifier of the second candidate cell having a same value as the identifier of the current cell. In some implementations of the NE, the processor, and the method described herein, the cell reselection procedure has failed based on expiry of a timer associated with the cell reselection procedure for the first candidate cell, and where the cell reselection procedure for the first candidate cell is from the current cell to the first candidate cell.

In some implementations of the NE, the processor, and the method described herein, the NE, the processor, and the method may further be configured to, capable of, or operable to transmit second signaling that includes at least one of an NCC associated with a handover complete message in RRC signaling from the first candidate cell, an identifier of the first candidate cell, or a TA associated with the first candidate cell. In some implementations of the NE, the processor, and the method described herein, the security key derivation information includes at least one of an NCC associated with at least one of the current cell or the second candidate cell, a frequency corresponding to the second candidate cell, or a PCI corresponding to the second candidate cell. In some implementations of the NE, the processor, and the method described herein, the first signaling includes RRC signaling, and the second signaling includes a MAC-CE.

### BRIEF DESCRIPTION OF THE DRAWINGS

FIG. 1 illustrates an example of a wireless communications system in accordance with aspects of the present disclosure.

FIG. 2 illustrates an example of a signaling diagram, in accordance with aspects of the present disclosure.

FIG. 3 illustrates an example of a key derivation diagram, in accordance with aspects of the present disclosure.

FIG. 4 illustrates an example of a signaling diagram, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system may include one or more devices, such as UEs and NEs, that transmit and receive signaling. For example, a UE may move from a coverage area of an NE, which may be referred to as a serving cell or a cell, to a coverage area of a different NE. The UE may exchange signaling as part of a cell reselection procedure (e.g., a cell switch procedure) to switch from a current cell to a target cell. The UE and the NE may use security keys as part of the cell reselection procedure to protect communications between the UE and the NE. For example, during the cell reselection procedure, the UE and an NE of a target cell may derive new security keys using key derivation information (e.g., an NCC parameter) to securely transmit and receive signaling. An NE can trigger a cell reselection procedure by transmitting higher layer signaling (e.g., RRC signaling) to the UE with key derivation information for a target cell.

Relying on higher layer signaling for switching cells (e.g., serving cells), rather than lower layer signaling (e.g., a MAC-CE or downlink control information (DCI)), which is more dynamic than higher layer signaling, may lead to increased latency between cell switches and increased signaling overhead. Thus, to reduce latency and signaling overhead related to relying on higher layer signaling for switching cells, an NE can implement higher layer signaling to configure a set of candidate target cells for the cell reselection procedure and can subsequently activate one of the configured candidate target cells as a target cell for the cell reselection procedure using lower layer signaling, such as a MAC-CE. However, the MAC-CE may include security key derivation information for a single target cell, and the cell reselection procedure to the single target cell may fail. Thus, the UE may be unable to complete the cell reselection procedure to the target cell, leading to additional signaling from the NE to configure additional security key derivation information for a different target cell, as well as latencies and delays related to the UE monitoring for and processing the additional signaling prior to establishing a wireless connection with a new cell.

As described herein, to reduce signaling overhead and delays related to a failed cell reselection procedure (e.g., cell switch procedure), an NE can include security key derivation information for additional candidate cells in signaling that activates or indicates target candidate cells for a cell reselection procedure (e.g., a MAC-CE). Additionally, or alternatively, the NE can include identifier information of different candidate cells in initial configuration information (e.g., RRC signaling). For example, the NE can transmit initial higher layer signaling that configures a set of candidate target cells and a corresponding set identifier for each candidate target cell. The set identifier can indicate to the UE sets of one or more cells that share security key derivation information. The NE can subsequently transmit lower layer signaling that activates a candidate target cell and that optionally includes security key derivation information (e.g., NCC parameters) for multiple candidate cells. If a cell reselection procedure from a current cell to the candidate target cell fails, then the UE can use the security key derivation information of another candidate cell (e.g., included in the lower layer signaling) to obtain a security key for the other candidate cell. The UE can use the security key to attempt an additional cell reselection procedure from the current cell to the other candidate cell (e.g., without additional signaling). If the lower layer signaling does not include security key derivation information for multiple candidate cells, then the UE can select another candidate cell with a set identifier that matches the current cell. The UE can use the security key derivation information of the current cell to obtain a security key for the other candidate cell (e.g., by performing horizontal key derivation), and can perform a cell reselection procedure from the current cell to the other candidate cell using the security key. In some examples, the terms cell and serving cell may be used interchangeably in the context of a cell reselection and/or cell switching. Further, the term cell reselection and cell switching may also be used interchangeably to describe a process for switching from a current cell to a target cell.

By performing the described techniques, a UE in a wireless communications system can perform a cell reselection procedure to a target candidate cell without additional signaling if an initial cell reselection procedure fails. Thus, the described techniques can reduce signaling overhead and improve resource allocation by reducing or eliminating additional signaling that configure new security key derivation information after a failed cell switch attempt. Additionally, or alternatively, the UE may attempt cell switches to alternative candidate cells without waiting for the additional signaling from the NE, leading to reduced latency and reduced delays for cell reselection procedures at the UE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

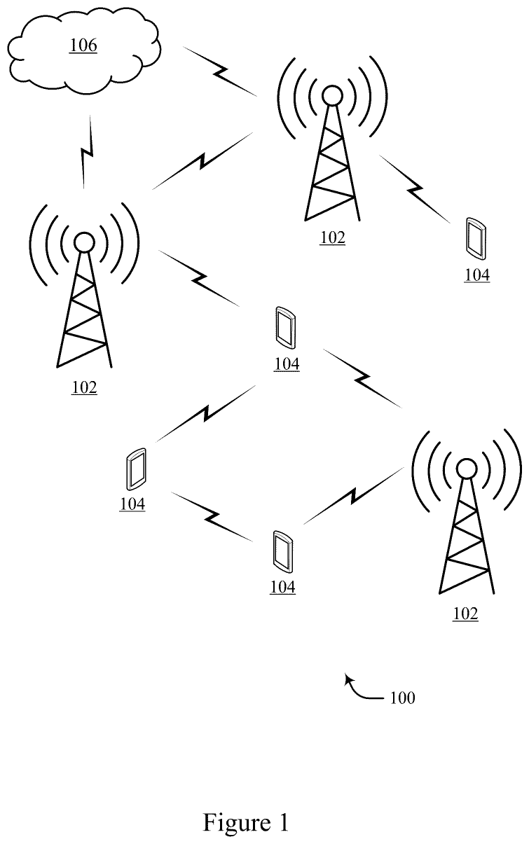

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, an NE 102 may be configured in a disaggregated architecture, which may be configured to utilize a protocol stack physically or logically distributed among two or more NEs 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the NEs 102 in a disaggregated RAN architecture may be co-located, or one or more components of the NEs 102 may be located in distributed locations (e.g., separate physical locations). In some implementations, one or more NEs 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU, such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective NEs 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (AS) (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, a cell refers to a geographic coverage area served by an NE, such as a base station and/or a gNB. A cell can correspond to a radio coverage provided by a single NE 102 or a defined sector of an NE 102. For example, a single NE 102 (e.g., gNB) may operate multiple cells, each using different frequency bands or covering different physical areas. A serving cell is a cell that a UE 104 is currently connected to and receiving service from. As a UE 104 moves through the wireless communications system 100, the UE 104 may enter different cells. Thus, the UE 104 may switch between serving cells to maintain connectivity, which is referred to as cell switching or handover. A cell reselection procedure, also referred to as a cell switch procedure, includes transferring a wireless connection from one cell to another. In some cases, multiple cells may be operated by a same NE 102. In some other cases, a cell switch may include moving from a cell operated by one NE 102 to a cell operated by a different NE 102.

The cell reselection procedure can include various types of signaling between an NE 102 and the UE 104. In some cases, the UE 104 may initiate a handover by transmitting signaling (e.g., a measurement report) to an NE 102 of a current serving cell. The NE 102 may process the signaling and transmit higher layer signaling and/or lower layer signaling that indicates one or more candidate target serving cells. The UE can disconnect from the NE 102 of the current serving cell and can exchange synchronization signals, among other information, with an NE 102 of a target serving cell to establish a connection between the UE 104 and the NE 102 of the target serving cell. In some examples, signaling may be described as being transmitted from a UE 104 to a serving cell, which includes the UE 104 transmitting the signaling to an NE 102 of the serving cell. Additionally, or alternatively, signaling may be described as being received from a serving cell, which includes the NE 102 of the serving cell transmitting the signaling to the UE 104.

In some examples, the NEs 102 and/or the UEs 104 in the wireless communications system 100 may implement one or more security protocols when exchanging signaling. For example, an NE 102 and a UE 104 may implement one or more security keys to protect data and other information exchanged via the signaling. The security keys, which may be examples of cryptographic keys and/or cryptographic key pairs, can include a public key and/or a private key that the UE 104 and the NE 102 can use to authenticate one another and/or to securely encrypt and decrypt the signaling. For a cell reselection procedure, the UE 104 and/or the NE 102 can use security keys to encrypt and authenticate communications. For example, if a UE 104 switches to a new serving cell, then the UE 104 and an NE 102 of the new serving cell may derive matching security keys to ensure secure communications can continue without interruption after the switch. The UE 104 and/or the NE 102 can derive the security keys using one or more parameters. The parameters can include, but are not limited to, a PCI, downlink frequency, and an NCC. The NCC parameter may be used to maintain synchronization between the UE 104 and the NE 102 during key derivation processes. In some cases, the NCC may reduce or prevent replay attacks by ensuring that each new key derivation uses a new input. A value of the NCC parameter may be incremented each time a new key is derived, providing for both the UE 104 and the NE 102 to track a current state of the key hierarchy and derive matching keys independently.

In some examples, an NE 102 can trigger a cell reselection procedure by transmitting higher layer signaling, such as RRC messages. However, to reduce latency and signaling overhead, the NE 102 may also implement lower layer triggered mobility (LTM) procedures. The LTM procedures enable serving cell changes (e.g., switches) via L1 or L2 signaling, which can be faster and more efficient when compared with higher layer signaling. Higher layer signaling may refer to communication protocols and messages that operate at higher levels of the network protocol stack, such as the RRC layer. In contrast, lower layer signaling may include protocols and messages at lower levels of the stack, such as the PHY or MAC layer.

In LTM procedures, an NE 102 may configure multiple candidate serving cells for a UE 104. The UE may receive this configuration information through an RRC reconfiguration message. Subsequently, the NE 102 may trigger a cell switch by sending a MAC-CE to the UE 104. The MAC-CE, also referred to as a cell switch command, can include information about a target candidate serving cell and may include an NCC for the target candidate serving cell used for deriving new security keys. However, the initial cell switch attempt to switch from a current serving cell to the target candidate serving cell indicated in the cell switch command may fail. For example, if the UE 104 is unable to establish a connection with the target candidate serving cell specified in the cell switch command, then the UE 104 may attempt a switch to a different candidate serving cell. The UE 104 may be unable to determine security key derivation information for alternative candidate serving cells, as the cell switch command may include security key derivation information for a single target candidate serving cell.

According to implementations, one or more of the NEs 102 and the UEs 104 are operable to implement various aspects of the techniques described with reference to the present disclosure. For example, a UE 104 may receive first signaling that indicates a set of candidate serving cells for a serving cell reselection procedure from a current serving cell. The UE 104 may then receive second signaling that indicates a target candidate serving cell of the set of candidate serving cells for the serving cell reselection procedure. In some cases, if the serving cell reselection procedure fails for the first candidate serving cell, the UE 104 may obtain a security key corresponding to a second candidate serving cell using security key derivation information for the second candidate serving cell or the current serving cell. For example, the second signaling may include additional security key derivation information for other candidate serving cells besides the first candidate serving cell. In some other examples, the UE 104 may use a set identifier to select a candidate serving cell that can use the same security key derivation information as the current serving cell. Thus, the UE 104 can attempt cell switches to alternative candidate serving cells without waiting for additional signaling from the NE 102, which reduces latency and improves the efficiency of serving cell reselection procedures.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

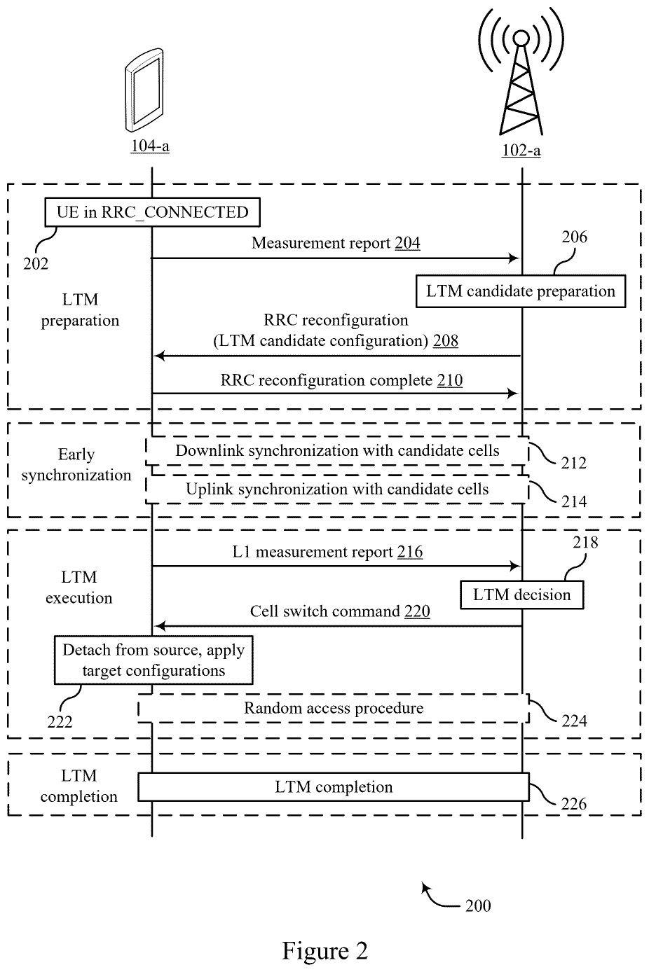

FIG. 2 illustrates an example of a signaling diagram 200 in accordance with aspects of the present disclosure. In some examples, the signaling diagram 200 implements or is implemented by aspects of the wireless communications system 100. The signaling diagram 200 may implement or be implemented by an NE 102-a and a UE 104-a, which may be examples of the corresponding devices as described with reference to FIG. 1. For example, the signaling diagram 200 may illustrate an example of a cell reselection procedure by a UE 104-a from a serving cell of an NE 102-a. Alternative examples of the following may be implemented, where some processes are performed in a different order than described or are not performed. In some cases, processes may include additional features not mentioned below, or further processes may be added.

In some examples, a UE 104-a moves from a coverage area of a current serving cell to a coverage area of another cell. The current serving cell may not remain a radio viable option due to a degradation of communication quality between the UE 104-a and the current serving cell. The UE 104-a may perform a serving cell switch (e.g., change) procedure to terminate communications with the current serving cell and to establish communications with a new serving cell. In some cases, the UE 104-a can trigger a serving cell switch by transmitting L3 measurements to the NE 102-a, where the serving cell switch is performed by an RRC signaling triggered reconfiguration with synchronization for change of a primary cell (PCell) and a primary secondary cell (PSCell), as well as release add for secondary cells (Scells), if applicable. The serving cell switch involves complete L2 (e.g., and L1) resets, leading to increased latency, increased signaling overhead, and increased interruption time when compared with beam switch mobility. The goal of L1 and/or L2 mobility enhancements is to enable a serving cell change via L1 and/or L2 signalling, to reduce a latency, overhead, and interruption time. Such a mobility is achieved using an LTM procedure using a cell switch command, which is conveyed in a MAC-CE.

For example, a cell switch command is conveyed in a MAC-CE, which includes information to perform the LTM cell switch. The overall procedure for LTM is shown in the signaling diagram 200. Subsequent LTM is done by repeating the early synchronization, LTM execution, and LTM completion steps without releasing other LTM candidate cell configurations after each LTM completion.

At 202, the UE 104-a is in an RRC_CONNECTED state. For example, the UE 104-a is in an active radio connection state, where the UE 104-a maintains a connection with the NE 102-a and can exchange data and/or control signaling.

At 204, the UE 104-a transmits a MeasurementReport message to the NE 102-a. The message includes one or more signal measurements of neighboring cells that the UE 104-a has detected.

At 206, the NE 102-a determines to configure LTM and initiates preparation of one or more candidate serving cells. LTM enables serving cell changes via lower layer signaling (e.g., L1 and/or L2 signaling), rather than via higher layer signaling, including RRC signaling.

At 208, the NE 102-a transmits an RRCReconfiguration message to the UE 104-a including the LTM candidate cell configurations of one or multiple candidate cells. The candidate cells may belong to a same NE or to another NE with a different security location. For example, the PDCP of a second NE (e.g., gNB or CU) is located separately from the one of the source NE (e.g., gNB or CU).

At 210, the UE 104-a stores the LTM candidate cell configurations and transmits an RRCReconfigurationComplete message to the NE 102-a.

In some cases, at 212, the UE 104-a may perform downlink synchronization with one or more candidate cells before receiving a cell switch command.

In some cases, at 214, the UE 104-a may perform uplink synchronization (e.g., early TA acquisition) with one or more candidate cells requested by the NE 102-a before receiving the cell switch command. The UE 104-a may perform the early TA acquisition via a contention free random access (CFRA) procedure triggered by a physical downlink control channel (PDCCH) order from a source cell. The UE 104-a sends preamble to the indicated candidate cell. To reduce (e.g., minimize) a data interruption of the source cell due to CFRA towards the candidate cells, the UE 104-a may not receive a random access response (RAR) for the purpose of TA value acquisition. The TA value of the candidate cell may be indicated in the cell switch command. The UE 104-a may not maintain a TA timer for the candidate cell and may rely on network implementation for TA validity.

At 216, the UE 104-a performs L1 measurements on a configured candidate cells and transmits a lower layer measurement report to the NE 102-a. The UE 104-a may perform the L1 measurements over a duration for which the UE 104-a applies the RRC reconfiguration received at 208. The measurements can include, but are not limited to, signal strength and quality indicators. The NE 102-a can use the measurements to determine a target candidate serving cell for the UE 104-a.

At 218, the NE 102-a determines to execute a cell reselection procedure for the UE 104-a from a current serving cell to a target candidate serving cell. For example, the NE 102-a may evaluate the measurements reported at 216, as well as network criteria (e.g., load balancing, among other examples), and selects a target candidate serving cell for the UE 104-a.

At 220, the NE 102-a transmits a cell switch command to the UE 104-a in lower layer signaling. For example, the NE 102-a transmits a MAC-CE triggering the cell switch (e.g., LTM) by including the candidate configuration index of the target candidate serving cell. The NE 102-a may also include an NCC if the UE 104-a is to perform security key derivation for the included target candidate serving cell. If the NCC has a same value as the current NCC in use for security context with the current serving cell (e.g., the source serving cell or source cell), then the UE 104-a may perform a horizontal key derivation. If the NCC has a different value than the current NCC in use for security context with the current serving cell, then UE 104-a may perform a vertical key derivation. The NE 102-a can also indicate that the UE 104-a may keep using the current security keys. Thus, the UE 104-a may not perform a key derivation responsive to an explicit indication or if the MAC-CE does not include the NCC value. The presence of an NCC in the MAC-CE is indicated by a Boolean flag.

At 222, the UE 104-a detaches from the source cell (e.g., a current serving cell), switches to the target serving cell, and applies the configuration indicated by candidate configuration index.

In some cases, at 224, the UE 104-a performs a random access procedure with the target candidate serving cell. For example, if the UE 104-a does not have a valid TA of the target candidate serving cell, then the UE 104-a may perform the random access procedure. The random access procedure may include an exchange of random access channel (RACH) signaling, such as for a two-step random access procedure or for a four-step random access procedure.

At 226, the UE 104-a completes the LTM cell reselection procedure. For example, the UE 104-a sends an RRCReconfigurationComplete message to the target serving cell. If the UE 104-a has performed a random access procedure at 224, then the LTM execution is successfully completed when the random access procedure is successfully completed. If the UE 104-a does not perform a random access procedure at 224, then the LTM execution is successfully completed when the UE 104-a determines that an NE of the new serving cell has successfully received uplink data. The UE 104-a determines successful reception of the uplink data by receiving a PDCCH addressing a cell-radio network temporary identifier (C-RNTI) in the target serving cell, which schedules a new transmission following the uplink data.

In some examples, the UE 104-a may send the RRCReconfigurationComplete message each LTM execution. The UE 104-a may perform the process from 212 to 226 multiple times for subsequent LTM cell switch using the LTM candidate cell configurations provided at 208. Upon receiving the cell switch command MAC-CE (e.g., the cell switch command at 220), the UE 104-a starts a timer (e.g., T304). If the UE 104-a does not complete the LTM cell reselection procedure before the expiry of the timer, then the cell reselection procedure has failed. In some examples, the UE 104-a may initiate a recovery procedure upon expiry of the timer.

The UE 104-a initiates T304 upon reception of an RRCReconfiguration message including reconfigurationWithSync for the master cell group (MCG), upon reception of an RRCReconfiguration message including reconfigurationWithSync for a secondary cell group (SCG) not indicated as deactivated in the NR or evolved-universal terrestrial radio access (E-UTRA) message including the RRCReconfiguration message, or upon conditional reconfiguration execution (e.g., when applying a stored RRCReconfiguration message including reconfigurationWithSync). For the MCG and SCG, the UE 104-a initiates T304 upon an indication from lower layer that an LTM cell reselection procedure or cell switch command MAC-CE is triggered and, for the MCG, upon performing an LTM cell reselection procedure following cell selection performed while an additional timer (e.g., T311) is running. The UE 104-a stops (e.g., terminates) the T304 upon successful completion of random access on the corresponding special cell (SpCell) (e.g., PCell or PSCell). Additionally, or alternatively, the UE 104-a stops the T304 upon receiving an indication from lower layers of successful completion of a handover without random access or upon receiving an indication from lower layers of successful completion of an LTM (e.g., cell switch command MAC-CE) cell switch without random access. For a T304 of an SCG, the UE 104-a stops the T304 upon SCG release. In some cases, at expiry of the T304, for a T304 of an MCG and for a handover from NR or intra-NR handover, or an LTM cell reselection procedure, the UE 104-a initiates an RRC re-establishment procedure. For handover to NR, the UE 104-a performs one or more defined (e.g., preconfigured, configured, specified) actions applicable for a source radio access technology (RAT). For a T304 of an SCG, the UE 104-a informs the network (e.g., via the NE 102-a) about the reconfiguration with synchronization failure by initiating the SCG failure information procedure.

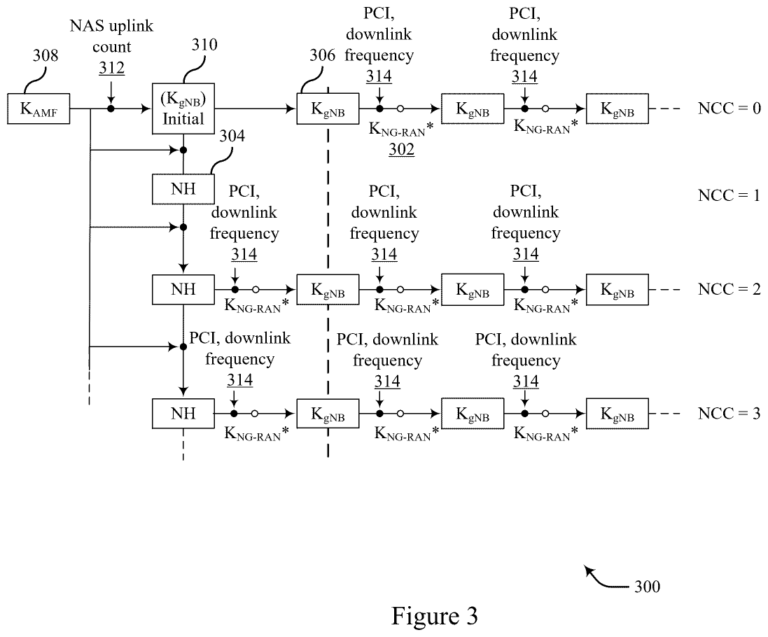

FIG. 3 illustrates an example of a key derivation diagram 300 in accordance with aspects of the present disclosure. In some examples, the key derivation diagram 300 implements or is implemented by aspects of the wireless communications system 100 and the signaling diagram 200. For example, the key derivation diagram 300 may be implemented by a UE and/or an NE, which may be an example of a UE 104 and an NE 102 as described with reference to FIGS. 1 and 2. The key derivation diagram 300 illustrates an example of key management for a K_{NG-RAN}* 302 and/or next hop (NH) parameter 304 at handovers.

If an initial AS security context is to be established between a UE and an NE (e.g., an gNB, next generation-evolved Node B (ng-eNB), AMF), then the UE may derive a key of the NE, K_{NE}, which may also be referred to as a K_{gNB} 306 and an NH parameter 304. The K_{gNB} 306 and the NH parameter 304 are derived from a K_{AMF} 308. An NCC is associated with each K_{gNB} 306 and NH parameter 304. A K_{gNB} 306 is associated with an NCC corresponding to the NH parameter 304 from which the K_{gNB} 306 was derived. At an initial setup, an initial K_{gNB} 310 is derived directly from K_{AMF} 308 according to an NAS uplink count 312, and is then considered to be associated with a virtual NH parameter with NCC value equal to zero. At the initial setup, the derived NH parameter 304 is associated with the NCC value one. In some cases, at the UE, the NH derivation associated with NCC=1 may be delayed until the first handover performing vertical key derivation. For an N2 handover, if the K_{gNB} 306 is updated either due to a change in the K_{AMF} 308 or synchronizing the AS security context with the NAS security context, the UE may derive the K_{gNB} 306. The UE may also derive the K_{gNB} 306 for in inter-RAT handover and for UE context modification.

Whether the AMF sends the K_{gNB} 306 or an {NH, NCC} pair to the serving NE (e.g., gNB, ng-eNB) can be defined (e.g., preconfigured, specified). The AMF may not send the NH parameter 304 to the NE at the initial connection setup. The UE may initialize the NCC value to zero after receiving a next generation application protocol (NGAP) initial context setup request message. Since the AMF does not send the NH parameter 304 to the NE at the initial connection setup, the NH parameter 304 associated with the NCC value one cannot be used in the next Xn handover or the next intra-gNB and/or intra-ng-eNB-CU handover. In some cases, for the next Xn handover or the next intra-gNB-CU and/or intra-ng-eNB handover the horizontal key derivation applies.

One of the rules specified for the AMF states that the AMF computes a fresh {NH, NCC} pair that is given to the target NE. Thus, the first {NH, NCC} pair may not be used to derive a K_{gNB} 306. The first {NH, NCC} pair serves as an initial value for the NH chain. The UE and the NE use the K_{gNB} 306 to secure the communication between one another. On handovers and at transitions from RRC_INACTIVE to RRC_CONNECTED states, the basis for the K_{gNB} 306 that the UE and the target NE use, referred to as K_{NG-RAN}* 302, is derived from either the currently active K_{gNB} 306 or from the NH parameter 304. The K_{NG-RAN}* 302 being derived from the currently active K_{gNB} 306 is referred to as a horizontal key derivation. The K_{NG-RAN}* 302 being derived from the NH parameter 304 the derivation is referred to as a vertical key derivation.

As NH parameters 304 are computable by the UE and the AMF, the NH parameters 304 are provided to the NE from the AMF to achieve forward security. On handovers with vertical key derivation, the NH parameter 304 is further bound to a target PCI and a downlink frequency 314 (e.g., an absolute radio frequency channel number-downlink (ARFCN-DL)) before the NH parameter 304 is taken into use as the K_{gNB} 306 at the target NE. On handovers with horizontal key derivation, the currently active K_{gNB} 306 is further bound to the target PCI and a downlink frequency 314 (e.g., an ARFCN-DL) before the currently active K_{gNB} 306 is taken into use as the K_{gNB} 306 at the target NE.

The LTM MAC-CE based mobility may result in a security key change depending on whether both the target and source DU (e.g., a base station and/or cell) are under a same CU. If the target and source DU are not under a same CU, then the UE may perform a security key change. By enabling LTM operation between cells of different NEs (e.g., inter-CU) the network gains the benefits of LTM for a far greater number of handovers compared with mobility inside a same NE (e.g., gNB or CU). The source to target CU change also means a change of PDCP location. The PDCP location change leads to a change in security parameters. The UE may not know an identifier of an NE (e.g., CU identifier or gNB identifier) of a cell. Thus, the UE may not know if the target serving cell included in the MAC-CE belongs to a different CU or not. A set identifier is used as a proxy to indicate to the UE which candidate and or source cells belong to a same security context. The network may include an NCC in the MAC-CE if the set identifier of the source and target serving cells are different and a security change is to be performed.

In some cases, a triggered mobility execution may fail at a UE (e.g., due to radio changes). Thus, the UE may benefit from executing a handover to a different candidate cell. The RRC configuration for each configured candidate cell (e.g., at 208 of the signaling diagram 200) is provided to the UE. A handover to another candidate cell can be useful in recovery from mobility failure to an original target serving cell. Upon successful handover, the UE can directly use the corresponding RRC configuration to configure lower layers, signaling radio bearers (SRBs), and/or data radio bearers (DRBs), avoiding additional delay at the target side. However, because the cell switch command MAC-CE includes NCC information for a single target serving cell, the UE may be unable to determine if a same NCC is also to be used for another cell that may be used for recovery. Thus, the UE may be unable to perform a recovery from lower layer mobility failure.

In some cases, the UE can compare the set identifier of the selected candidate for recovery with the set identifier of the target serving cell, where set identifiers are configured in the candidate cell configuration at 208 in the signaling diagram 200. If the set identifier of the chosen candidate for recovery is the same as the set identifier of the target serving cell, then the UE can use the signaled NCC, derive new keys and perform mobility to the selected candidate cell.

In some examples, an NE of a current serving cell can include the NCC for the target serving cell and also at least one more candidate cell configured at 208 of the signaling diagram 200 in the cell switch command MAC-CE (e.g., at 220 of the signaling diagram 200). For an LTM recovery, the UE may use a candidate cell (e.g., other than the target serving cell) for which the NCC is included in the cell switch command MAC-CE. The UE derives new keys based on the received NCC and performs mobility to the selected candidate cell. The NE may determine which cells to include (e.g., along with the corresponding NCC) value in the MAC-CE. For example, the NE can select the candidate cells to include in the MAC-CE using one or more recent radio measurements received from the UE, or based on patterns or network experience in knowing towards which candidate cells a UE may be moving.

Upon receiving the cell switch command MAC-CE, the UE may store (e.g., preserve, save) the configuration being used at the source before triggering the mobility execution. That is, before starting the mobility execution based on the received cell switch command MAC-CE, the UE saves the current source configuration in separate variables. The current source configuration can include the SRB and DRB configuration, such as PDCP, RLC states, variables, and the security configuration (e.g., security keys and the data stored in transmission and reception buffers in PDCP and RLC entities), among other information. The UE can use the stored configuration upon mobility failure to the target serving cell (e.g., upon expiry of a timer T304 started upon receiving cell switch command MAC-CE). Upon mobility failure to the target serving cell included in the cell switch command MAC-CE, the UE attempts to use security key derivation information for other candidate serving cells included in the MAC-CE, if present (e.g., other NCCs included in the MAC-CE). If there is no security key derivation information for other candidate serving cells in the MAC-CE, then the UE reverts to the stored configuration used at the source. Further, for an LTM recovery, the UE may select a candidate cell (e.g., other than the target serving cell) with a set identifier that is the same as that of the source cell. The set identifier of the source cell is also provided to the UE at 208 of the signaling diagram 200. If such a candidate cell is found, then the UE may use a same security context (e.g., same keys and algorithm) to perform mobility to the selected candidate cell. If such a candidate cell is not found, then the UE may instead perform an RRC connection re-establishment procedure.

Additionally, or alternatively, upon mobility failure to a target candidate serving cell, instead of using the same security keys, the UE may use a horizontal key derivation using the current NCC, frequency of the selected candidate cell, and the PCI of the candidate cell as input to derive new keys. The choice if to continue to use the source security context or to make horizontal key derivation first, can be configured by the network (e.g., as part of the RRC Configuration at 208 in the signaling diagram 200) and can be candidate cell specific. Additionally, or alternatively, the UE may implement a default of whether to continue to use the source security context or to make horizontal key derivation first. After the UE derives new keys based on the current NCC, the UE performs mobility to the selected candidate cell.

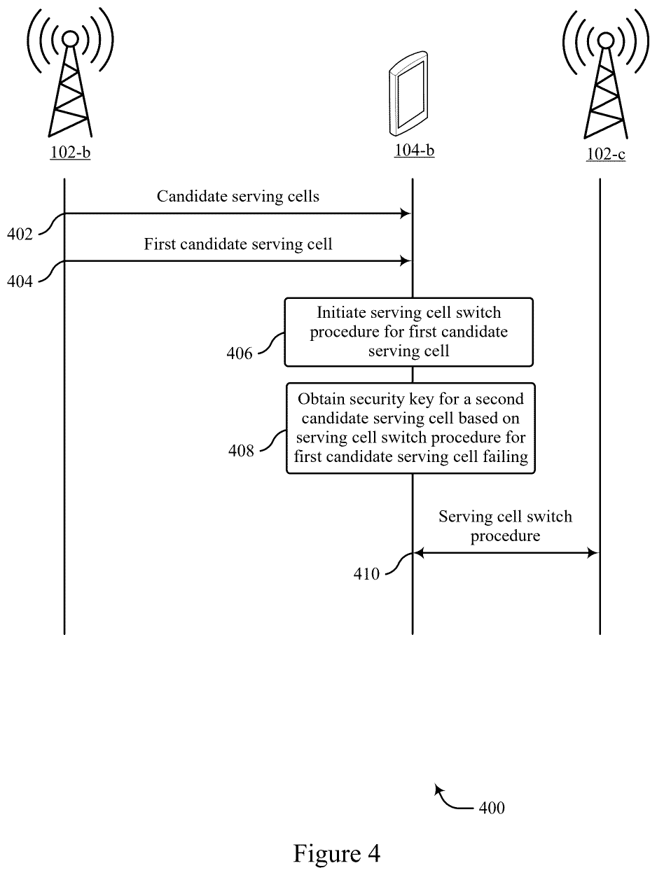

FIG. 4 illustrates an example of a signaling diagram 400 in accordance with aspects of the present disclosure. In some examples, the signaling diagram 200 implements or is implemented by aspects of the wireless communications system 100, the signaling diagram 200, and the key derivation diagram 300. The signaling diagram 400 may implement or be implemented by an NE 102-b, an NE 102-c, and a UE 104-b, which may be examples of the corresponding devices as described with reference to FIGS. 1 through 3. For example, the signaling diagram 400 may illustrate an example of a cell reselection procedure by a UE 104-b from a serving cell of an NE 102-b to a serving cell of an NE 102-c. Alternative examples of the following may be implemented, where some processes are performed in a different order than described or are not performed. In some cases, processes may include additional features not mentioned below, or further processes may be added. Although the NE 102-b and the NE 102-c are illustrated as being different devices, in some cases, the NE 102-b and the NE 102-c may be different devices or may be a same device.

At 402, the UE 104-b receives first signaling from the NE 102-b that indicates a set of candidate serving cells for a serving cell reselection procedure from a current (e.g., source) serving cell. The first signaling includes RRC signaling and includes respective identifiers of the set of candidate serving cells and an identifier of the current serving cell. For example, the RRC signaling can include a list or table of identifiers of the set of candidate serving cells. The NE 102-b can configure any numerical quantity of candidate serving cells in the RRC signaling. The first signaling may include a set identifier for each candidate serving cell, which serves as a proxy to indicate to the UE 104-b which candidate cells belong to the same security context. For example, the UE 104-b can use the set identifier to determine whether candidate cells belong to a same CU or different CUs, which affects security key derivation criterion. The RRC signaling configures the LTM candidate cell configurations that the UE 104-b stores for potential use in subsequent mobility procedures.

At 404, the UE 104-b receives second signaling from the NE 102-b that indicates a first candidate serving cell of the set of candidate serving cells for the serving cell reselection procedure. The second signaling includes a MAC-CE and includes at least one of an NCC of a handover complete message in RRC signaling from the first candidate serving cell, an identifier of the first candidate serving cell, or a TA of the first candidate serving cell. The second signaling may also indicate one or more additional target candidate serving cells and corresponding security key derivation information for the additional target candidate serving cells (e.g., any numerical quantity of additional target candidate serving cells). For example, the second signaling may indicate a second candidate serving cell, first security key derivation information for the first candidate serving cell, and second security key derivation information for the second candidate serving cell. The MAC-CE, which may also be referred to as a cell switch command, triggers the LTM by including the candidate configuration index of the target serving cell (e.g., the NE 102-c).

The NE 102-b may determine a numerical quantity of additional target candidate serving cells (e.g., and the corresponding security key derivation information), as well as may select the additional target candidate serving cells to include in the MAC-CE. The NE 102-b may use recent radio measurements received from the UE 104-b to select the additional target candidate serving cells and to determine the numerical quantity of additional target candidate serving cells. Additionally, or alternatively, the NE 102-b may determine (e.g., detect, obtain, identify) one or more patterns related to a movement of the UE 104-b, including towards which candidate serving cells a UE 104-b may be moving. The NE 102-b may use the patterns to select the additional target candidate serving cells and to determine the numerical quantity of additional target candidate serving cells. For example, if the NE 102-b determines the UE 104-b is moving in a defined direction (e.g., northeast at 17 degrees), then the NE 102-b may indicate one or more additional target candidate serving cells and corresponding security key derivation information for candidate serving cells in that direction. In some examples, the MAC-CE may include one or more additional parameters that explicitly indicate the additional target candidate serving cells and the corresponding security key derivation information. For example, the MAC-CE can include a bitmap that indicates the additional target candidate serving cells and the corresponding security key derivation information, where a value of respective bits in the bitmap indicate whether a target candidate serving cell is activated by the MAC-CE as a target candidate serving cell.

At 406, the UE 104-b initiates a timer for the serving cell reselection procedure and initiates the serving cell reselection procedure for the first candidate serving cell from the current serving cell to the first candidate serving cell. The UE 104-b determines the serving cell reselection procedure has failed for the first candidate serving cell based on expiry of the timer. The UE 104-b starts the timer (e.g., T304) upon receiving the cell switch command MAC-CE. Before starting the mobility execution based on the received cell switch command MAC-CE, the UE 104-b stores (e.g., saves, preserves) the current source configuration in separate variables. If the UE 104-b cannot complete the LTM cell reselection procedure before the expiry of the timer, then the cell reselection procedure has failed, and a recovery procedure is initiated.

At 408, based on the serving cell reselection procedure failing for the first candidate serving cell, the UE 104-b obtains a security key for a second candidate serving cell of the set of candidate serving cells using security key derivation information for at least one of the second candidate serving cell or the current serving cell. In some cases, such as if the MAC-CE includes security key derivation information for the second candidate serving cell, then the security key derivation information includes the second security key derivation information. The security key derivation information can include, but is not limited to, at least one of an NCC associated with at least one of the current serving cell or the second candidate serving cell, a frequency corresponding to the second candidate serving cell, or a PCI of the second candidate serving cell. The UE 104-b may attempt to use security key derivation information (e.g., NCCs) for other candidate serving cells included in the MAC-CE for performing an additional serving cell reselection procedure from the current serving cell to the other candidate serving cells. For example, if the MAC-CE includes security key derivation information for multiple candidate serving cells, then the UE 104-b can derive new keys based on the received security key derivation information for an alternative candidate serving cell.

If the MAC-CE does not include security key derivation information for multiple candidate serving cells, then the UE 104-b reverts to the stored source configuration and selects a candidate cell with a same set identifier as the current serving cell (e.g., source cell). For example, the UE 104-b selects the second candidate serving cell based on the respective identifier of the second candidate serving cell having a same value as the identifier of the current serving cell. The UE 104-b may either continue to use the same security context (e.g., same keys and algorithm) or may perform a horizontal key derivation using a current NCC, a frequency of the selected candidate cell, and a PCI of the candidate cell as input to derive new keys. The NE 102-b can configure the UE 104-b to continue using the source security context or to perform a horizontal key derivation (e.g., as part of the signaling at 402). For example, the NE 102-b can configure the UE to use the source security context or to perform a horizontal key derivation on a per candidate cell basis. Additionally, or alternatively, the UE 104-b may use the source security context or may perform a horizontal key derivation according to a default configuration.

At 410, the UE 104-b performs the serving cell reselection procedure for the second candidate serving cell based on the security key. After deriving the new keys using either the stored security key derivation information and/or using security key derivation information for the second candidate serving cell included in the signaling at 404, the UE 104-b switches from the current serving cell to the second candidate serving cell. In some examples, if the UE 104-b is unable to switch to a candidate cell, then the UE performs an RRC connection re-establishment procedure.

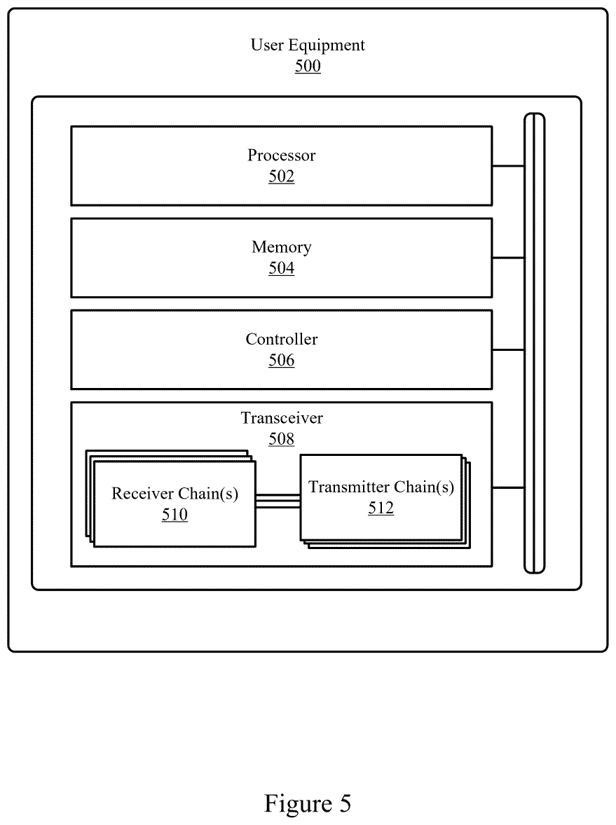

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate-array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving first signaling that indicates a set of candidate cells for cell reselection, receiving second signaling that indicates a first candidate cell of the set of candidate cells for the cell reselection, obtaining, based on a failure of a cell reselection procedure for the first candidate cell, a security key corresponding to a second candidate cell of the set of candidate cells using security key derivation information associated with at least one of the second candidate cell or a current cell, and performing, based on the security key, the cell reselection procedure for the second candidate cell.

Additionally, the UE 500 may be configured to support any one or combination of the second signaling indicates the second candidate cell and the security key derivation information, where the security key derivation information is associated with the second candidate cell. Additionally, or alternatively, the UE 500 may be configured to support the first signaling includes a set of identifiers of the set of candidate cells and an identifier of the current cell, and selecting the second candidate cell based on a respective identifier of the second candidate cell having a same value as the identifier of the current cell. Additionally, or alternatively, the UE 500 may be configured to support initiating a timer associated with the cell reselection procedure, performing, based on initiating the timer, the cell reselection procedure for the first candidate cell, where the cell reselection procedure for the first candidate cell is from the current cell to the first candidate cell, and determining the cell reselection procedure has failed for the first candidate cell based on expiry of the timer.

Additionally, or alternatively, the UE 500 may be configured to support the second signaling includes at least one of an NCC associated with a handover complete message in RRC signaling from the first candidate cell, an identifier of the first candidate cell, or a TA associated with the first candidate cell. Additionally, or alternatively, the UE 500 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the UE 500 may be configured to support the first signaling includes RRC signaling, and the second signaling includes a MAC-CE.

Additionally, or alternatively, the UE 500 may support at least one memory (e.g., the memory 504) and at least one processor (e.g., the processor 502) coupled with the at least one memory and configured to cause the UE to receive first signaling that indicates a set of candidate cells for cell reselection, receive second signaling that indicates a first candidate cell of the set of candidate cells for the cell reselection, obtain, based on a failure of a cell reselection procedure for the first candidate cell, a security key corresponding to a second candidate cell of the set of candidate cells using security key derivation information associated with at least one of the second candidate cell or a current cell, and perform, based on the security key, the cell reselection procedure for the second candidate cell.

Additionally, the UE 500 may be configured to support any one or combination of the second signaling indicates the second candidate cell and the security key derivation information, where the security key derivation information is associated with the second candidate cell. Additionally, or alternatively, the UE 500 may be configured to support the first signaling includes a set of identifiers of the set of candidate cells and an identifier of the current cell, and selecting the second candidate cell based on a respective identifier of the second candidate cell having a same value as the identifier of the current cell. Additionally, or alternatively, the UE 500 may be configured to support to initiate a timer associated with the cell reselection procedure, perform, based on initiating the timer, the cell reselection procedure for the first candidate cell, where the cell reselection procedure for the first candidate cell is from the current cell to the first candidate cell, and determine the cell reselection procedure has failed for the first candidate cell based on expiry of the timer.

Additionally, or alternatively, the UE 500 may be configured to support the second signaling includes at least one of an NCC associated with a handover complete message in RRC signaling from the first candidate cell, an identifier of the first candidate cell, or a TA associated with the first candidate cell. Additionally, or alternatively, the UE 500 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the UE 500 may be configured to support the first signaling includes RRC signaling, and the second signaling includes a MAC-CE.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

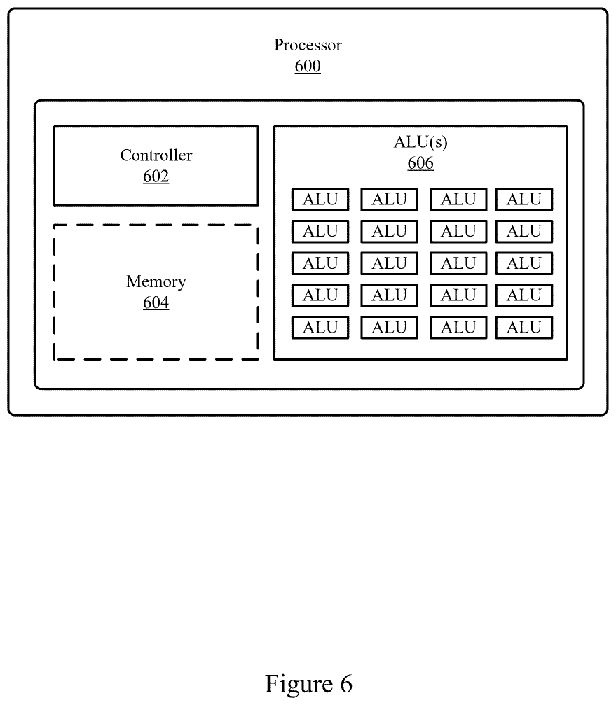

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive first signaling that indicates a set of candidate cells for cell reselection, receive second signaling that indicates a first candidate cell of the set of candidate cells for the cell reselection, obtain, based on a failure of a cell reselection procedure for the first candidate cell, a security key corresponding to a second candidate cell of the set of candidate cells using security key derivation information associated with at least one of the second candidate cell or a current cell, and perform, based on the security key, the cell reselection procedure for the second candidate cell.

Additionally, the processor 600 may be configured to or operable to support any one or combination of the second signaling indicates the second candidate cell and the security key derivation information, where the security key derivation information is associated with the second candidate cell. Additionally, or alternatively, the processor 600 may be configured to support the first signaling includes a set of identifiers of the set of candidate cells and an identifier of the current cell, and selecting the second candidate cell based on a respective identifier of the second candidate cell having a same value as the identifier of the current cell. Additionally, or alternatively, the processor 600 may be configured to support to initiate a timer associated with the cell reselection procedure, perform, based on initiating the timer, the cell reselection procedure for the first candidate cell, where the cell reselection procedure for the first candidate cell is from the current cell to the first candidate cell, and determine the cell reselection procedure has failed for the first candidate cell based on expiry of the timer.

Additionally, or alternatively, the processor 600 may be configured to support the second signaling includes at least one of an NCC associated with a handover complete message in RRC signaling from the first candidate cell, an identifier of the first candidate cell, or a TA associated with the first candidate cell. Additionally, or alternatively, the processor 600 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the processor 600 may be configured to support the first signaling includes RRC signaling, and the second signaling includes a MAC-CE.

The processor 600 may be configured to or operable to support at least one controller (e.g., the controller 602) coupled with at least one memory (e.g., the memory 604) and configured to cause the processor to transmit first signaling that indicates a set of candidate cells for cell reselection, and transmit second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell.

Additionally, the processor 600 may be configured to or operable to support any one or combination of the second signaling indicates the second candidate cell and the security key derivation information, where the security key derivation information is associated with the second candidate cell. Additionally, or alternatively, the processor 600 may be configured to support the first signaling includes a set of identifiers of the set of candidate cells and an identifier of the current cell, where the second candidate cell is selected based on a respective identifier of the second candidate cell having a same value as the identifier of the current cell. Additionally, or alternatively, the processor 600 may be configured to support the cell reselection procedure has failed based on expiry of a timer associated with the cell reselection procedure for the first candidate cell, where the cell reselection procedure for the first candidate cell is from the current cell to the first candidate cell.

Additionally, or alternatively, the processor 600 may be configured to support the second signaling includes at least one of an NCC associated with a handover complete message in RRC signaling from the first candidate cell, an identifier of the first candidate cell, or a TA associated with the first candidate cell. Additionally, or alternatively, the processor 600 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the processor 600 may be configured to support the first signaling includes RRC signaling, and the second signaling includes a MAC-CE.

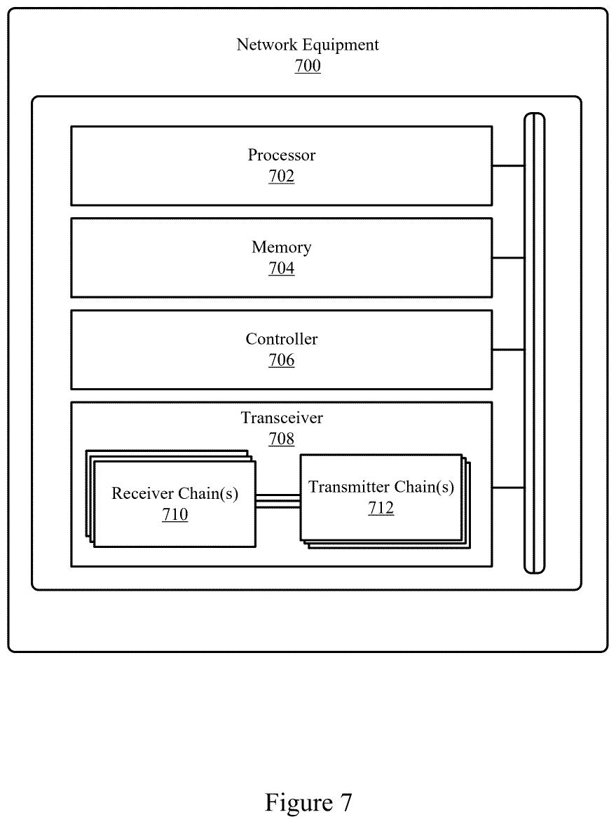

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting first signaling that indicates a set of candidate cells for cell reselection, and transmitting second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell.

Additionally, the NE 700 may be configured to or operable to support any one or combination of the second signaling indicates the second candidate cell and the security key derivation information, where the security key derivation information is associated with the second candidate cell. Additionally, or alternatively, the NE 700 may be configured to support the first signaling includes a set of identifiers of the set of candidate cells and an identifier of the current cell, where the second candidate cell is selected based on a respective identifier of the second candidate cell having a same value as the identifier of the current cell. Additionally, or alternatively, the NE 700 may be configured to support the cell reselection procedure has failed based on expiry of a timer associated with the cell reselection procedure for the first candidate cell, and where the cell reselection procedure for the first candidate cell is from the current cell to the first candidate cell.

Additionally, or alternatively, the NE 700 may be configured to support the second signaling includes at least one of an NCC associated with a handover complete message in RRC signaling from the first candidate cell, an identifier of the first candidate cell, or a TA associated with the first candidate cell. Additionally, or alternatively, the NE 700 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the NE 700 may be configured to support the first signaling includes RRC signaling, and the second signaling includes a MAC-CE.

Additionally, or alternatively, the NE 700 may support at least one memory (e.g., the memory 704) and at least one processor (e.g., the processor 702) coupled with the at least one memory and configured to cause the NE to transmit first signaling that indicates a set of candidate cells for cell reselection, and transmit second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell.

Additionally, the NE 700 may be configured to support any one or combination of the second signaling indicates the second candidate cell and the security key derivation information, where the security key derivation information is associated with the second candidate cell. Additionally, or alternatively, the NE 700 may be configured to support the first signaling includes a set of identifiers of the set of candidate cells and an identifier of the current cell, where the second candidate cell is selected based on a respective identifier of the second candidate cell having a same value as the identifier of the current cell. Additionally, or alternatively, the NE 700 may be configured to support the cell reselection procedure has failed based on expiry of a timer associated with the cell reselection procedure for the first candidate cell, and where the cell reselection procedure for the first candidate cell is from the current cell to the first candidate cell.

Additionally, or alternatively, the NE 700 may be configured to support the second signaling includes at least one of an NCC associated with a handover complete message in RRC signaling from the first candidate cell, an identifier of the first candidate cell, or a TA associated with the first candidate cell. Additionally, or alternatively, the NE 700 may be configured to support the security key derivation information includes at least one of an NCC associated with at least one of the current cell or the second candidate cell, a frequency corresponding to the second candidate cell, or a PCI corresponding to the second candidate cell. Additionally, or alternatively, the NE 700 may be configured to support the first signaling includes RRC signaling, and the second signaling includes a MAC-CE.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., an LNA) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

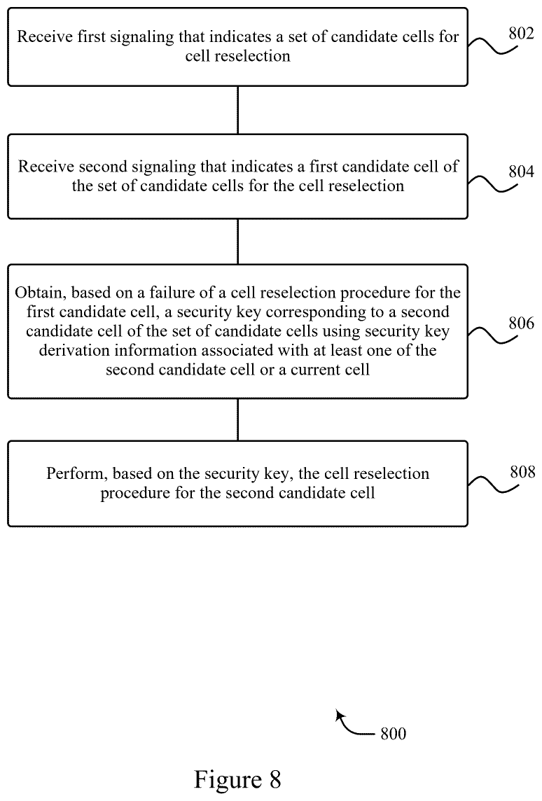

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving first signaling that indicates a set of candidate cells for cell reselection. The operations of 802 may be performed in accordance with examples as described herein. In some implementations, aspects of the operations of 802 may be performed by a UE as described with reference to FIG. 5.

At 804, the method may include receiving second signaling that indicates a first candidate cell of the set of candidate cells for the cell reselection. The operations of 804 may be performed in accordance with examples as described herein. In some implementations, aspects of the operations of 804 may be performed by a UE as described with reference to FIG. 5.

At 806, the method may include obtaining, based on a failure of a cell reselection procedure for the first candidate cell, a security key corresponding to a second candidate cell of the set of candidate cells using security key derivation information associated with at least one of the second candidate cell or a current cell. The operations of 806 may be performed in accordance with examples as described herein. In some implementations, aspects of the operations of 806 may be performed a UE as described with reference to FIG. 5.

At 808, the method may include performing, based on the security key, the cell reselection procedure for the second candidate cell. The operations of 808 may be performed in accordance with examples as described herein. In some implementations, aspects of the operations of 808 may be performed a UE as described with reference to FIG. 5.

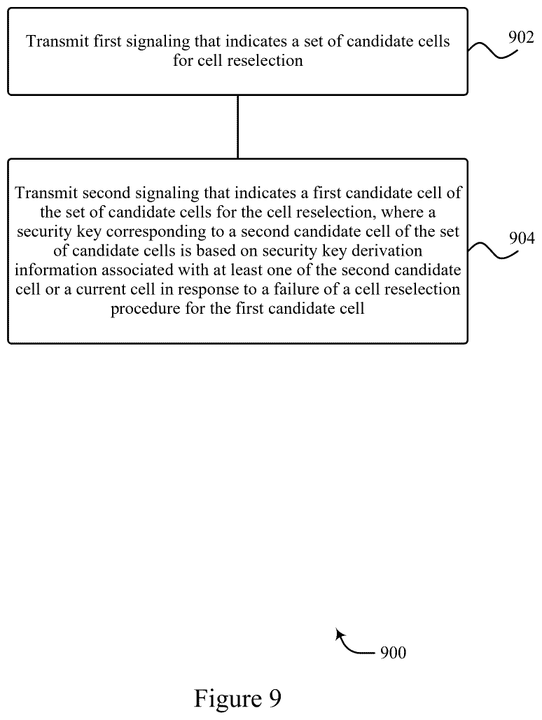

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting first signaling that indicates a set of candidate cells for cell reselection. The operations of 902 may be performed in accordance with examples as described herein. In some implementations, aspects of the operations of 902 may be performed by an NE as described with reference to FIG. 7.

At 904, the method may include transmitting second signaling that indicates a first candidate cell of the set of candidate cells for the cell reselection, where a security key corresponding to a second candidate cell of the set of candidate cells is based on security key derivation information associated with at least one of the second candidate cell or a current cell in response to a failure of a cell reselection procedure for the first candidate cell. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first signaling that indicates a plurality of candidate cells for cell reselection;
receive second signaling that indicates a first candidate cell of the plurality of candidate cells for the cell reselection;
obtain, based at least in part on a failure of a cell reselection procedure for the first candidate cell, a security key corresponding to a second candidate cell of the plurality of candidate cells using security key derivation information associated with at least one of the second candidate cell or a current cell; and
perform, based at least in part on the security key, the cell reselection procedure for the second candidate cell.

2. The UE of claim 1, wherein the second signaling indicates the second candidate cell and the security key derivation information, and wherein the security key derivation information is associated with the second candidate cell.

3. The UE of claim 1, wherein the first signaling comprises a plurality of identifiers of the plurality of candidate cells and an identifier of the current cell, and wherein the at least one processor is further operable to cause the UE to select the second candidate cell based at least in part on a respective identifier of the second candidate cell having a same value as the identifier of the current cell.

4. The UE of claim 1, wherein the at least one processor is further operable to cause the UE to:
initiate a timer associated with the cell reselection procedure;
perform, based at least in part on initiating the timer, the cell reselection procedure for the first candidate cell, wherein the cell reselection procedure for the first candidate cell is from the current cell to the first candidate cell; and
determine that the cell reselection procedure has failed for the first candidate cell based at least in part on expiry of the timer.

5. The UE of claim 1, wherein the second signaling comprises at least one of a next-hop chaining counter (NCC) associated with a handover complete message in radio resource control (RRC) signaling from the first candidate cell, an identifier of the first candidate cell, or a timing advance (TA) associated with the first candidate cell.

6. The UE of claim 1, wherein the security key derivation information comprises at least one of a next-hop chaining counter (NCC) associated with at least one of the current cell or the second candidate cell, a frequency corresponding to the second candidate cell, or a physical cell identity corresponding to the second candidate cell.

7. The UE of claim 1, wherein the first signaling comprises radio resource control (RRC) signaling, and wherein the second signaling comprises a medium access control-control element (MAC-CE).

8. A method performed by a user equipment (UE), the method comprising:
receiving first signaling that indicates a plurality of candidate cells for cell reselection;
receiving second signaling that indicates a first candidate cell of the plurality of candidate cells for the cell reselection;
obtaining, based at least in part on a failure of a cell reselection procedure for the first candidate cell, a security key corresponding to a second candidate cell of the plurality of candidate cells using security key derivation information associated with at least one of the second candidate cell or a current cell; and
performing, based at least in part on the security key, the cell reselection procedure for the second candidate cell.

9. The method of claim 8, wherein the second signaling indicates the second candidate cell and the security key derivation information, and wherein the security key derivation information is associated with the second candidate cell.

10. The method of claim 8, wherein the first signaling comprises a plurality of identifiers of the plurality of candidate cells and an identifier of the current cell, and wherein the method further comprises selecting the second candidate cell based at least in part on a respective identifier of the second candidate cell having a same value as the identifier of the current cell.

11. The method of claim 8, further comprising:
initiate a timer associated with the cell reselection procedure;
perform, based at least in part on initiating the timer, the cell reselection procedure for the first candidate cell, wherein the cell reselection procedure for the first candidate cell is from the current cell to the first candidate cell; and
determine that the cell reselection procedure has failed for the first candidate cell based at least in part on expiry of the timer.

12. The method of claim 8, wherein the second signaling comprises at least one of a next-hop chaining counter (NCC) associated with a handover complete message in radio resource control (RRC) signaling from the first candidate cell, an identifier of the first candidate cell, or a timing advance (TA) associated with the first candidate cell.

13. A network equipment (NE) for wireless communication, comprising:
at least one memory; and
at least one processor coupled with the at least one memory and operable to cause the NE to:
transmit first signaling that indicates a plurality of candidate cells for cell reselection; and
transmit second signaling that indicates a first candidate cell of the plurality of candidate cells for the cell reselection, wherein a security key corresponding to a second candidate cell of the plurality of candidate cells is based at least in part on security key derivation information associated with at least one of the second candidate cell or a current cell in response to a failure of a cell reselection procedure for the first candidate cell.

14. The NE of claim 13, wherein the second signaling indicates the second candidate cell and the security key derivation information, and wherein the security key derivation information is associated with the second candidate cell.

15. The NE of claim 13, wherein the first signaling comprises a plurality of identifiers of the plurality of candidate cells and an identifier of the current cell, and wherein the second candidate cell is selected based at least in part on a respective identifier of the second candidate cell having a same value as the identifier of the current cell.

16. The NE of claim 13, wherein the cell reselection procedure has failed based at least in part on expiry of a timer associated with the cell reselection procedure for the first candidate cell, and wherein the cell reselection procedure for the first candidate cell is from the current cell to the first candidate cell.

17. The NE of claim 13, wherein the second signaling comprises at least one of a next-hop chaining counter (NCC) associated with a handover complete message in radio resource control (RRC) signaling from the first candidate cell, an identifier of the first candidate cell, or a timing advance (TA) associated with the first candidate cell.

18. The NE of claim 13, wherein the security key derivation information comprises at least one of a next-hop chaining counter (NCC) associated with at least one of the current cell or the second candidate cell, a frequency corresponding to the second candidate cell, or a physical cell identity corresponding to the second candidate cell.

19. The NE of claim 13, wherein the first signaling comprises radio resource control (RRC) signaling, and wherein the second signaling comprises a medium access control-control element (MAC-CE).

20. A method performed by a network equipment (NE), the method comprising:
transmitting first signaling that indicates a plurality of candidate cells for cell reselection; and
transmitting second signaling that indicates a first candidate cell of the plurality of candidate cells for the cell reselection, wherein a security key corresponding to a second candidate cell of the plurality of candidate cells is based at least in part on security key derivation information associated with at least one of the second candidate cell or a current cell in response to a failure of a cell reselection procedure for the first candidate cell.
